(19) United States
(12) Patent Application Publication
(10) Pub. No.: US 2004/0037315 A1
(43) Pub. Date: Feb. 26, 2004

(54) Method for transmitting a mobile agent in a network, associated transmitter, receiver and mobile agent

(76) Inventors: Antoine Delautre, Franconville (FR); Sebastien Gillardeau, Asnieres (FR); Pascal Ruiz, Paris (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/311,851

(22) PCT Filed: Jun. 29, 2001
(86) PCT No.: PCT/FR01/02096

(30) Foreign Application Priority Data
Jun. 30, 2000 (FR) 00 08515

(51) Int. Cl. H04J 3/16

(52) U.S. Cl. 370/466; 370/310

(57) ABSTRACT

The invention relates to the transmission of autonomous executable code and/or of associated data in a network. It includes the placing into bitstream form of the executable code C (stage T2) and of the associated data D (stage T3) of a mobile agent A before converting them into a bitstream to be sent f_{A} (stage T4). After the conventional digital processing operations on reception (stages R1 to R5), the receiving node N_{R} receiving this stream f_{A} extracts the code C and the parameters D (stages R8 and R9). The code C is run autonomously (stage E2) then the code C and its runtime context (associated parameters and resulting data) are again converted into a bitstream f_{A} transmitted to the next node (stages T). The final node recovers the data D_{R} resulting from the running of the code C on the nodes N of the route P (stage R11).

The invention relates to the transmission of executable code in a network.

One solution is the use of a mobile agent. The mobile agent includes executable code, data and the run-time status. It is said to be mobile since it is capable of being executed and of migrating, autonomously, onto various nodes of a network at different instants. The transmission not only of executable code C but also of elements such as, especially, data D, a route P, allows the code C to be executable autonomously.

In general, the mobile agent is transmitted from one node to another in file form, for example in the form of code produced by the compilation of the source code giving rise to executable or interpretable code.

The transmission of a mobile agent on a network poses problems relating to the type of network borrowed. Let us consider the radio network, for example; the principal difficulties encountered are:

low transmission throughput,

strong disturbances,

indefinite and fluctuating visibility, etc.

Effective processing operations, matched to the executable code object, the standard format of which is of bytecode-file type, have been investigated and developed so as to allow it to be transmitted. The processing operations in question are effective in proportion to the size of the file (the larger the file the more effective is the processing). For “conventional” message-exchange techniques including mobile agents, it is necessary to develop a protocol, since the above-mentioned techniques are no longer viable. However, a protocol is generally cumbersome, expensive and complex.

The present invention makes it possible to overcome these drawbacks, by transmitting, in the form of a bitstream, a mobile agent A including at least autonomous executable code C and/or associated data D and/or following a route P. This code C is run autonomously on the nodes N of the route P, storing the data obtained D_{R} and the run time context during the transmission D_{E}.

The invention proposes a method of transmitting a mobile agent including at least executable code and/or associated data D by a sending node to at least one node in a network, characterized in that it includes at least the following stages:

the conversion of said mobile agent into a bitstream to be sent, and

the sending of said bitstream.

The various stages of this transfer process are carried out by a mobile-agent sender in a network, characterized in that it includes at least the following means:

a general, mobile agent into bitstream to be sent, converter, including at least the following attributes:

an input receiving a mobile agent,

an output delivering the resulting bitstream to be sent,

a bitstream sender including an input receiving said bitstream to be sent.

The invention also proposes a method of receiving a mobile agent including at least executable code and associated data by a node of a network, characterized in that it includes at least the following stages:

the receiving of a bitstream,

the extraction of the mobile agent from said received bitstream.

The various stages of this reception process are carried out by a mobile-agent receiver, characterized in that it includes at least the following means:

a bitstream receiver receiving a bitstream,

a mobile-agent extractor, extracting the mobile agent from a bitstream and including at least one of the following attributes:

an input receiving said received bitstream,

an output delivering said extracted mobile agent.

More generally, the invention proposes a node of a network including said mobile-agent sender and/or said mobile-agent receiver, characterized in that it includes at least one or more of the following devices:

a mobile-agent source, characterized in that it includes at least the following means:

an interface including at least one or more of the following inputs:

[symbol] an input receiving the choice of the executable code of the mobile agent,

[symbol] an input receiving the choice of the data associated with the mobile agent,

[symbol] an input receiving the choice of the method of selection S and/or of route of the target nodes,

[symbol] an input receiving the choice of a method TR of transfer of the data D_{R} resulting from the running of the mobile agent,

a reading member (L) including at least one or more of the following attributes:

[symbol] a link with said interface,

[symbol] a pointer associating an address with the incoming data in at least one internal or external memory (MEM), the address at which at least some or all of the mobile agent (A) is located,

[symbol] an output delivering the mobile agent (A) read to a sender,

a microprocessor including an interface with a mobile agent allowing said mobile agent including code to manage, autonomously, at least the running of said code by said microprocessor.

The characteristics and advantages of the invention will become more clearly apparent on reading the description, given by way of example, and the figures relating thereto which represent:

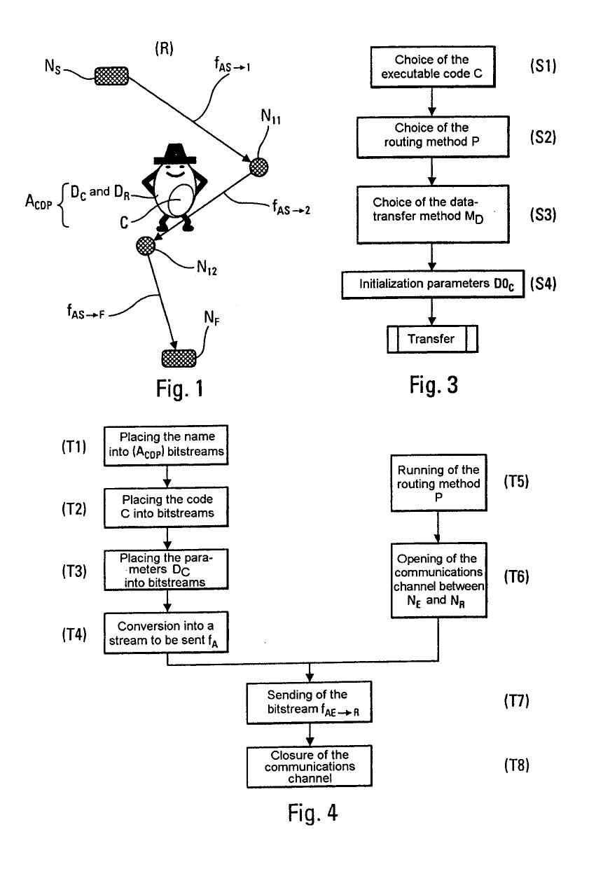

FIG. 1, a theoretical diagram of the migration of an agent in a network,

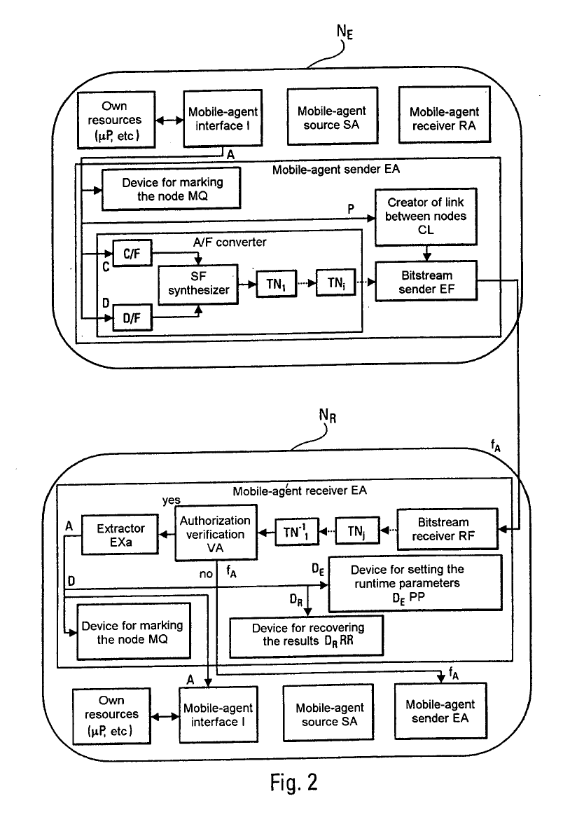

FIG. 2, an example of transmission of a mobile agent A from a sending node N_{E} to a receiving node N_{R},

FIG. 3, a theoretical diagram of the initialization of the migration of an agent in the network according to the invention,

FIG. 4, a theoretical diagram of the method for transfer of an agent from one node to another node of the network according to the invention,

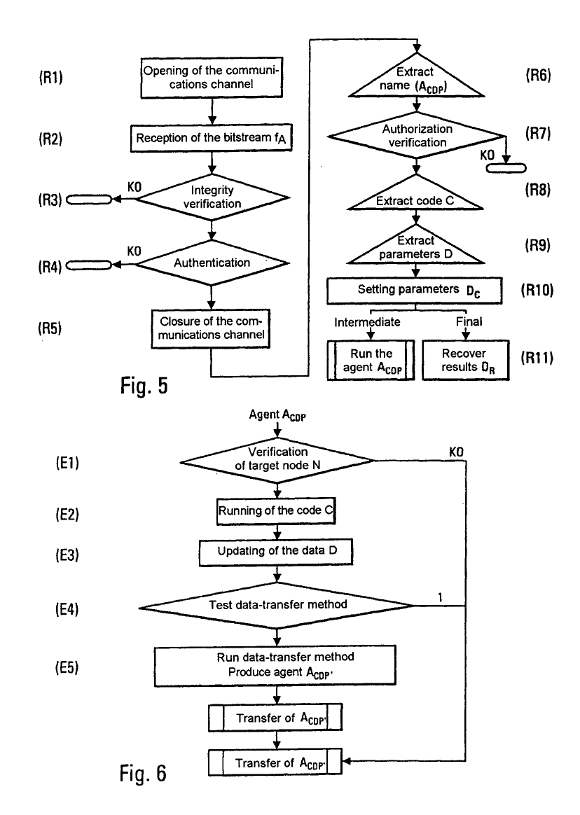

FIG. 5, a theoretical diagram of the reception method of an agent on a node of the network according to the invention,

FIG. 6, a theoretical diagram of the running of the code of the agent on the receiving node.

The nodes N of a network R include, for example, three types of structure for hosting a mobile agent A:

Source. This structure makes it possible to constitute a mobile agent A (choice of the code, of the parameters), to define its route P and to initialize its migration in the network R. It therefore comprises a mobile agent source SA and a mobile-agent sender EA.

Intermediate. This structure receives a mobile agent A, allows it to be run and resends it to at least one new node N. It therefore comprises a mobile agent sender EA and a receiver RA.

Final. This structure receives a mobile agent A and recovers the set of data D_{R} resulting from the running of the code C of said mobile agent A on various nodes N of the route P. It therefore comprises a mobile-agent receiver RA.

Thus, a single node may be source N_{S} as regards a first mobile agent A₁, intermediate N₁ as regards a second A₂ and final N_{F} as regards a third A₃. Furthermore, the source node N_{S} as regards a given mobile agent A may also be the final node N_{F} of the same mobile agent A.

The mobile agent A includes the executable code C, the associated data D, the method P of traveling the network R and various interfaces I depending on its host node N_{H}, for example:

an initialization interface with the source node Nₛ making it possible to receive the parameters D of the mobile agent A, and to indicate the route to be traveled,

a run interface making it possible to use the resources of the intermediate nodes N_{I} during the running of the code C of the mobile agent A,

a next-machine interface making it possible to indicate the next destination node N to the intermediate nodes N_{I},

a response interface allowing the final node N_{F} to recover the data D.

Furthermore, the mobile agent A meets the following characteristics:

independence of the host node N_{H}, since its code C can be run on various computers including:

various microprocessors (machine language, size of the machine words, etc),

different operating systems,

access to coded data taking place in different languages (C, ADA, etc),

different representations of the basic types (CHAR, INT, BYTE, etc)

transfer of the executable code C from the mobile agent A as well as of its run-time context from one node N to another. To do that, a mechanism for conversion of the agent into a bitstream f_{A} is put in place within each host structure.

dynamic-link loading and editing, since the running of the code C of the mobile agent A in the host structure of the node N calls on dynamic-link loading and editing principles, if no link-editing is envisaged in local mode on the host node N.

The mobile agent A may, for example, be produced in JAVA. In order to allow a JAVA virtual machine (JVM for short), that is to say to allow the operating system for running of the JAVA bytecode, it is necessary to extend the standard ClassLoader. This is because the ClassLoader which has been developed does not load the classes from a file but from a byte table. This format, extremely simple and widespread, makes it possible to dispense completely with the classes-transmission channel as well as with their storage mode. It is therefore independent of any specialist protocol.

(Initialization N_{S})

FIG. 1 shows a theoretical diagram of migration of a mobile agent A in a network R. The mobile agent A is defined within the source node N_{S}, and its migration in the network R initialized from this same source node N_{S} as FIG. 3 presents.

The definition of the mobile agent A consists in choosing the executable code C (stage S1), the method for transfer of the data D_{R} resulting from the running, on each node N, of this code C to the final node N_{F} (stage S2), the route P for migration of the agent A onto the target nodes N_{c} of the network R (stage S2) and the initial run-time parameters D0_{E} of said executable code C (stage S4). The data D contained in the agent A may, for example, be information, messages, parameters, etc.

The definition of the method for transfer of the data, resulting from the running of code C, to the final node N_{F} consists, for example, within each node N, in making the choice to transmit the resultant data D_{R} directly or indirectly to the final node N_{F} depending on the selection criterion, which may be the volume of resulting data D_{R} obtained. The definition of the route P is done via the choice of a method P of routing through the target nodes N_{C}. This routing method P may, for example, be simply a list of target nodes N_{C} with the route order, or a criterion for selection of the target nodes {N}.

All the stages S are carried out by a mobile-agent source within the source node Nₛ which are present in each node N of the network R as FIG. 2 shows.

(Sending N_{S}→N_{I1})

In order to allow the transfer of the mobile agent A (stages T), that is to say of the autonomous executable code C and of the associated parameters D, the code is, first of all, converted into a bitstream f_{A} to be sent by the mobile-agent sender EA of the source node N_{S}, similar to that proposed as an example in FIG. 2, then the stream f_{A} is sent on a given communications channel as proposed, for example, by FIG. 4.

The conversion of the code C into a bitstream corresponds to a conversion not on its very nature but on the manner in which it is perceived by the environment in which it resides. This, to some extent, is a change of “status”. Transmission in bitstream form makes it possible not only to transmit the code C but the data D, the route P . . . allowing it to be autonomous.

The name of the mobile agent Name[A], the executable code C of this mobile agent A and the parameters D associated with the code C of this mobile agent A are put into the form of bitstreams (stage T1 to T3) by various individual converters: C/F as regards the code, D/F as regards the data, etc. The various bitstreams are converted into one stream to be sent f_{A}, that is to say are regrouped into a single stream by virtue of the synthesizer SF and undergo the conventional processing operations TN allowing the transmission of digital data such as, for example, compression, error-correcting coding, cryptography, etc (stage T4). The running of the method P for routing through the target nodes N by the mobile agent A makes it possible to determine the parameters for transfer from the source node N_{S} to the first intermediate target node N_{I1} (stage T5). These parameters allow the link creator CL to open a communications channel between the sending node N_{E}, the source node N_{S} and the receiving node N_{R}, the first intermediate node N_{I1} (stage T6). The bitstream f_{AS→1} including the mobile agent A is then sent by the bitstream sender EF on the open channel to the first intermediate target node N_{I1} (stage T7). Once the sending is terminated, the channel is closed (stage T8).

In the case of a transfer by radio waves, for example, the definition of the route P may correspond to the number of radio hops or to a radio network R. In this case, the agent A records its route P and either includes an algorithm which allows it to determine the next node N_{R}, or accesses a service local to the host structure in order to determine the next node N_{R}. With the radio links fluctuating (being of variable quality in the course of time), it is difficult, a priori, to define the order for routing through the nodes N. It is therefore preferable to “leave” the agent A to establish its route P by indicating to it the initialization of a connection table of the network R and an associated resolution algorithm.

(Reception N_{I1})

FIG. 4 shows the method employed for receiving a mobile agent A by the mobile-agent receiver RA of the receiving node N_{R}, intermediate node N_{I1}. First of all, the communications channel between the sending node N_{E} (source node N_{S}) and the receiving node N_{R} (first intermediate node N_{I1}) has been opened as described above for FIG. 3 (stage R1⇄Stage T6). The bitstream receiver RF of the intermediate node N_{I1} thus receives the bitstream f_{AS→1} including the mobile agent A sent by the source node N_{S} (stage R2). If the integrity of the received stream f_{AS→1} is verified (stage R3), the received stream f_{AS→1} is authenticated by virtue, for example, of encryption (stage R4). These stages are carried out by digital-processing devices TN⁻¹. Once the bitstream f_{AS→1} including the mobile agent A has been received, the communications channel is closed as indicated above during the description of igure 3 (stage R5⇄stage T8).

If the received stream f_{AS→1} including the mobile agent A has been verified and authenticated (stages R3 and R4), the name of the mobile agent NAME[A] is extracted from the stream f_{AS→1} (stage R6).

The authorization to run said agent A on the intermediate node N_{I1} is verified by an authorization verifier VA (stage R7). This authorization allows the code C of the mobile agent A to access the resources of the receiving node N_{R} (first intermediate node N_{I1}). The authorization resides in the fact that in the event, for example, of inconsistency between the host structures and the agents, the mobile agent A cannot be run. The use, for example, for the interfaces of the interface agent of “proprietary” type, which are able to fulfill the role of access key explicitly (dedicated interface) or implicitly makes it possible to prevent the introduction of an external and undesired agent to the system.

If the agent A is not authorized to be run on said node N_{I1}, it may, for example, be resent immediately to a new node, either an intermediate node N_{I2} or final node N_{F} of the network R by the sender EA of the node N_{I1}.

If the agent A is authorized to be run on said node N_{I1}, the executable code C is extracted from said received stream f_{AS→1} (stage R8) as well as the parameters D associated with said code C (stage R9) by the mobile-agent extractor EXa. The parameters D0_{E} are set in such a way as to initialize the running of said code C (stage R10) by the setting device PP. Then, the agent A can be run (stages E) before being transferred onto a new node, either an intermediate node N_{I1} or a final node N_{F} (stages T).

(Running N_{I1})

FIG. 5 proposes a method of running the mobile agent A. The agent A first of all verifies whether the intermediate node N_{I1} is a target node N_{C} (stage E1). If this is not the case, it immediately triggers its transfer onto a new either intermediate node N_{I2} or final node N_{F} (stages T).

If the intermediate node N_{I1} is a target node, the code is run (stage E2) by using the resources (microprocessor μP, etc) of the host node N_{H}, intermediate node N_{I1}. The data D including the parameters D of the code C and the data D_{R} resulting from the running of the code C are updated (stage E3). The updated parameters D include the data making it possible to continue the running of the code C on a new node. They record the context in which the code C is found at the moment when its running is fixed before the transfer of the mobile agent A onto this new node.

The resulting data D_{R}, for their part, can be transmitted in several ways including, for example, with the mobile agent A like the parameters D, or with a new mobile agent A′. A test is carried out in order to discover the method which will be used to transfer the data D_{R} (stage E4). This test may, for example, be based on the volume of data D_{R} to be transmitted. Below a certain volume (branch 1), the data D_{R} are transferred with the mobile agent A like the parameters D (stages T). Above this volume (branch 2), the data-transfer method makes it possible to form a new agent A′ including these data D_{R} (stage E5).

The intermediate transmission of the data DR makes it possible to prevent the transfer of a mobile agent of large volume, and thus to avoid substantial use of the passband, which makes it possible to limit transmission errors. When a mobile agent A gathers information it will, in fact, be capable of transmitting the intermediate results D_{R} to the final node N_{F} either by establishing a direct or indirect link, or by generating a transport agent A′ (stage E5).

(Sending N_{I1}→N_{I1})

Next, this new mobile agent A′ including the results D_{R} is transferred onto the final node N_{F}, and the original mobile agent A is transferred onto a new node N. The transfers of the mobile agents A and A′ are effected from this first intermediate node N_{I1} towards, respectively, a new node N and the final node N_{F}, for example in the same way as the transfer of the mobile agent A from the source node N_{S} to the node N_{I1} (stages T) by a sender EA having a structure similar to that of the sender EA of the source node N_{S}.

(Reception N_{I2})

If the mobile agent A is again received on an intermediate node N_{I}, the stages R of reception, E of running and T of transfer of the mobile agent A are identical to those carried out on the first intermediate node and are carried out by a receiver RA identical to that of the first intermediate node.

(Final Reception)

The reception of a mobile agent A on a final node N_{F} includes the same stages R1 to R10 and is carried out by the same type of receiver RA as described above during the reception of an agent A on an intermediate node N_{I}. As FIG. 4 shows, the supplementary stage during final reception is that of recovery of the results of the running D_{R} (stage R11). The recovery of all the data resulting from the running of the code C of a mobile agent A on the set of nodes N of its route N can be carried out on the basis of one or more mobile agents A, see A′ . . . by a supplementary means of the receiver RA: a results-recovery device RR.

In order to reduce the size of the mobile agent A and to enhance its effectiveness, it is possible to implement all or some of the functionalities of the mobile agent A, that is to say some or all of the code C, in the host structure of the nodes N. The mobile agent A transferred then includes the parameters and, if appropriate, the residual part of the code which is not implemented in the host structure. In this case, the generic quality of the structure is degraded, which will have the consequence of reducing the maneuvering options of the mobile agents. This is one solution for obtaining a high level of security. Furthermore, this is very suitable for the access and updating of operational parameters of a node N. In the event of a new type of agent A, it will be necessary to deploy a new host structure.

The devices described above can be identical in each node or specific to a node or a sub-network. For example the mobile-agent source SA and/or the recovery device RR of the receiver RA may be present solely in a supervisor node.

The use of a mobile agent A in a network R allows, among other things, supervision and administration of the network R during applications such as, for example:

the configuring and the updating of the content of the nodes N (distribution of information to a network, a sub-network, etc)

information gathering (recovery of status, centralization of operational data, etc),

remote action (running: multi-criteria search on each node, for example),

the revealing of topology,

polling (validation of each of the links of a network, automatic detection of the addition or of the deletion of a node without human intervention, for example),

the recording or the learning of the route PE taken by the mobile agent A (this allows the mobile agent A to “recover its path”: radio hop, resending, data transmission with the use of this route PE, etc)

verification of a network by broadcasting a request for authentication, etc.

Each node is capable of embarking a service (not necessarily the same one) and of making available the federation of nodes to which it is connected. Hence, it is possible significantly to increase the number of functionalities by distributing them among the various nodes. Each node belonging to a federation may use the functionalities displayed by the other nodes of this same federation. To do that, it addresses a request, in the form of a mobile agent A_{RL}, to the lookup service which establishes the link with a node N_{C} having this functionality available. The code C is then downloaded in the form of a mobile agent A, to the client node on which it is run.

The node including the lookup process distributes the requests on the basis of the availability of the services and of the workload. It can also supply statistics on use of the various services so as to optimize their distribution on the various nodes.

The invention relates to any type of network, wired or otherwise. Its application, for example, to the radio network is possible. The communications channel of a radio network is a limited resource of variable quality over time. The use of the mobile agent is therefore very suitable to the mobile radio communications context since it makes it possible to transfer only the data necessary as opposed to a “conventional” request/response mechanism.

With the mobile agent A being transmitted in the form of a bitstream fA, it may undergo the same processing as any digital data stream, such as:

compression making it possible to reduce the passband used,

verification of the integrity of the transfer (by software tattooing, for example). The method for verification of integrity of the transfer may, for example, adapt the throughput of the link (coding) and the size of the packets transmitted as a function of the link quality, offering services of the checksum and segmentation/reassembling type.

placing into packet form,

coding.

One of the characteristics of a mobile agent A, in the radio case for example, is the fact that the running of the code C of the mobile agent A does not disturb the mobile operation or, at the very least, the RAM and CPU utilization is monitored in such a way as to prevent the long-term degradation of the performance.

Moreover, the radio network allows broadcasting of the mobile agent placed into the form of a bitstream instead of “conventional” point-to-point transmission. The broadcasting of a mobile agent A makes it possible to reduce the utilization of the radio passband. The mobile agent A is sent to all the nodes N within radio visibility. The mobile agent A is then collaborating with itself since it is likely to be received several times by the same node N. For example, the mobile agent A possesses an identifier (configuration-management form) so as not to be run several times by the same node N. A mapping device MQ, using the identifier of the mobile agent A, for example, can be used during one of the processes using the mobile agent within a node such as, for example, the running of the mobile agent, the sending of the mobile agent, the reception of the mobile agent (cf FIG. 2) etc. The mobile agent A is then capable of gathering in all the data collected D_{R} over its various routes.

1. A method of transmitting a mobile agent (A) in a network (R) including at least executable code (C) and/or associated data D, characterized in that it includes at least the following stages:
the conversion (A/F) of said mobile agent (A) into a bitstream (f_{A}) to be sent, and
the sending of said bitstream (f_{A}) by a sender node (N_{E}) towards at least one node (N) in said network (R).

2. The transmission method as claimed in the preceding claim, characterized in that it includes at least the following stages:
the conversion of the executable code (C) of said mobile agent (A) into bitstreams upon said conversion (A/F),
the conversion of the data (D) associated with said mobile agent (A) into bitstreams upon said conversion (A/F),
the combining of several bitstreams into a bitstream including said mobile agent (A) upon said conversion (A/F),
and/or the creation of a link between said node (N_{E}) and at least one node (N) in said network (R) on which said bitstream (fA) is sent.

3. The transmission method as claimed in the preceding claim, characterized in that this link creation includes at least the following stages:
the running of the method (P) of routing through the target nodes (Nc) on which the mobile agent (A) has to be run,
the generation of a transfer parameter upon the running of said routing method (P),
the use of a transfer parameter upon creation of said link,
the opening of a communications channel constituting the creation of said link,
and in that said transmission method includes the breaking-off of said link created.

4. The transmission method as claimed in one of the preceding claims, characterized in that it includes at least one of the following stages:
one or more digital processing operations (TN) carried out, upon said conversion (A/F), on a bitstream including said mobile agent (A), the set of said processing operation or operations {TN} delivering a bitstream to be sent (fA),
the marking of said sender node (N_{E}) by an identifier of said mobile agent (A).

5. The transmission method according to any one of the preceding claims, characterized in that it includes at least the following stages:
the receiving of a bitstream (f_{A}),
the extraction of the mobile agent (A) from said received bitstream (f_{A}).

6. The method of transmitting a mobile agent (A) as claimed in the preceding claim, characterized in that it includes at least the following stages:
the extraction of the executable code (C) from said received bitstream (f_{A}) upon the extraction of said mobile agent (A),
the extraction of the data (D) associated with said received bitstream (f_{A}) upon the extraction of said mobile agent (A),
the setting of the runtime parameters D_{E} comprised or not comprised in the extracted data (D).

7. The method of transmitting a mobile agent (A) as claimed in either of claims 5 and 6, characterized in that it includes at least one of the following stages:
one or more digital processing operations (TN⁻¹) on said received bitstream (f_{A}),
verification of the authorization to run, on said node (N_{R}), the mobile agent (A) contained in said received bitstream (f_{A}), triggering the extraction of said mobile agent (A),
the marking of said receiver node (N_{R}) by an identifier of said mobile agent (A).

8. A sender of a mobile agent in a network (R), characterized in that it includes at least the following means:
a general, mobile agent into bitstream to be sent (A/F), converter, including at least the following attributes:
an input receiving a mobile agent (A),
an output delivering the resulting bitstream (f_{A}) to be sent,
a bitstream sender (EF) including an input receiving said bitstream (f_{A}) to be sent.

9. The sender as claimed in the preceding claim, characterized in that said general converter (A/F) includes at least the following attributes:
an individual, executable code into bitstream, converter (C/F) receiving the executable code (C) of said mobile agent (A),
an individual, data into bitstream, converter (D/F), receiving the data (D) associated with said mobile agent (A),
a bitstream combiner (SF) including at least:
several inputs each receiving a bitstream of which none, one or more are each linked to the output of an individual converter,
an output delivering a bitstream including said mobile agent (A),

10. The sender as claimed in either of claims 8 and 9, characterized in that it includes a link controller (CL) between said mobile-agent sender (EA) and at least one receiver (RA) of the network (R) including at least the following attributes:
a means for managing the running of the method (P) for routing through the target nodes (N_{C}) on which the mobile agent (A) has to be run, running generating at least one of the following commands:
a link-generation command,
an order for opening of a communications channel constituting said link,
a link-generation command including the transfer parameters generated upon the running of said routing method (P),
an order for opening of a communications channel constituting said link including the transfer parameters generated upon the running of said routing method (P),
an output on which is delivered a signal including at least one of the following commands:
for generation of said link,
for opening of a communications channel constituting said link,
for breaking off said created link.

11. The sender as claimed in one of claims 8 to 10, characterized in that said bitstream sender (EF) includes at least:
either an output via which said stream (f_{A}) is broadcast to all the nodes (N) of said network (R),
or an output via which said stream (f_{A}) is transmitted to one or more predetermined nodes (N) in said network (R).

12. The sender as claimed in one of claims 8 to 11, characterized in that it includes at least:
one or more devices (TN) for digital processing of the bitstream including said mobile agent (A), delivering a bitstream (f_{A}) to be sent, as output of the set of said processing device or devices {TN}, and/or
a device (MQ) for marking said sender node (N_{E}) with an identifier of said mobile agent (A).

13. A mobile-agent receiver characterized in that it includes at least the following means:
a bitstream receiver (RF) receiving a bitstream (f_{A}),
a mobile-agent extractor (Exa), extracting the mobile agent from a bitstream and including at least one of the following attributes:
an input receiving said received bitstream (f_{A}),
an output delivering said extracted mobile agent (A).

14. The mobile-agent receiver as claimed in the preceding claim, characterized in that it includes at least one or more of the following means:
a verifier (VA) of the authorization to run the mobile agent (A) on the receiving node (N_{R}) including at least the following attributes:
an input linked to the output of the bitstream receiver receiving the received bitstream (f_{A}),
an output delivering said bitstream (f_{A}) to said mobile-agent extractor, if the verification is positive,
said mobile-agent extractor (Exa) including the following attributes:
an executable-code extractor linked to the input receiving said stream (f_{A}) and delivering the executable code (C) of the mobile agent (A) extracted from said stream (f_{A}),
a data extractor linked to the input receiving said stream (f_{A}) and delivering the data (D) associated with the mobile agent (A) and extracted from said stream (f_{A}),
a means (PP) for setting said runtime parameters D_{E} comprised or not comprised in the extracted data (D).

15. The mobile-agent receiver as claimed in either of claims 13 or 14, characterized in that it includes at least:
one or more devices for digital processing (TN⁻¹) of said received bitstream (f_{A}), and/or
a device (MQ) for marking said receiving node (N_{R}) with an identifier of said-mobile agent (A).

16. A node of a network (R) including a mobile-agent sender (EA) as claimed in either of claims 5 and 6 and/or a mobile-agent receiver (RA) as claimed in either of claims 7 and 8, characterized in that it includes at least one or more of the following devices:
a mobile-agent source (SA), characterized in that it includes at least the following means:
an interface (I) including at least one or more of the following inputs: [symbol]
an input receiving the choice of the executable code (C) of the mobile agent (A), [symbol]
an input receiving the choice of the data (D) associated with the mobile agent (A), [symbol]
an input receiving the choice of the method of selection S and/or of route (P) of the target nodes (N_{c}), [symbol]
an input receiving the choice of a method TR of transferring the data D_{R} resulting from the running of the mobile agent (A),
a reading member (L) including at least one or more of the following attributes: [symbol]
a link with said interface, [symbol]
a pointer associating an address with the incoming data in at least one internal or external memory (MEM), the address at which at least some or all of the mobile agent (A) is located, [symbol]
an output delivering the mobile agent (A) read to a sender,
a microprocessor (μP) including an interface with a mobile agent allowing said mobile agent (A) including code (C) to manage, autonomously, at least the running of said code (C) by said microprocessor.

17. Mobile agent including at least executable code (C) and/or associated data (D) and an interface with a node as claimed in the preceding claim, called host node (N_{H}), characterized in that it includes at least the following functions:
the verification that the host node (N_{H}) belongs to the set of nodes {N} on which the mobile agent (A) is to be run, including at least one or more of the following functions:
the triggering of the management of the running of the code (C) of the mobile agent (A), if the verification is positive,
the transmission of said mobile agent (A) to the mobile-agent sender of the said host node, if the verification is negative,
the transmission of said updated mobile agent (A) to the mobile-agent sender of said host node (N_{H}),
the testing of the method TR for transferring data D_{R} resulting from the running of the code (C) including at least one or more of the following functions:
the triggering of the management of the running of said method TR, if the test is positive,
the transmission of said mobile agent (A) including at least the code (C) and the updated data (D) to which the data D_{R} have been added, to the mobile-agent sender of the said host node, if the test is negative

18. A mobile agent as claimed in the preceding claim, characterized in that it includes at least one or more of the following functions:
the management of the running of the code (C) of the mobile agent (A),
the updating of the associated data (D) of the mobile agent (A) on the basis of one or more of the following data items:
the context D_{E} of said running,
the data D_{R} resulting from said running,

19. The mobile agent as claimed in either of claims 17 and 18, characterized in that it includes at least the management of the running of the method TR for transfer of the resulting data D_{R} including:
either the creation of a data D_{R}-transfer means and transmission of said data D_{R}-transfer means to a sender of said host node (N_{H}),
or the creation of a results mobile agent (A′) including at least the data D_{R} and transmission of said results mobile agent (A′) to the mobile-agent sender of said host node (N_{H}).
